(19) United States
(12) Patent Application Publication
(10) Pub. No.: US 2024/0361195 A1
(43) Pub. Date: Oct. 31, 2024

(54) SENSOR

(71) Applicant: ROHM CO., LTD., Kyoto (JP)

(72) Inventor: Masahiro SAKURAGI, Kyoto (JP)

(73) Assignee: ROHM CO., LTD., Kyoto (JP)

(21) Appl. No.: 18/642,297

(22) Filed: Apr. 22, 2024

(30) Foreign Application Priority Data
Apr. 27, 2023 (JP) 2023-073626

(51) Int. Cl. G01L 9/00

(52) U.S. Cl. CPC G01L 9/0045; G01L 9/0044; G01L 9/0051

(57) ABSTRACT

A sensor includes a substrate. A cavity is formed in the substrate. The substrate includes a membrane spaced from and facing a bottom surface of the cavity. A plurality of protruding portions are formed on one of the bottom surface of the cavity and an inner surface of the membrane.

### CROSS REFERENCE TO RELATED APPLICATIONS

This nonprovisional application is based on Japanese Patent Application No. 2023-073626 filed on Apr. 27, 2023 with the Japan Patent Office, the entire contents of which are hereby incorporated by reference.

### BACKGROUND OF THE INVENTION

### Field of the Invention

The present disclosure relates to a sensor.

### Description of the Background Art

For example, Japanese Patent Laying-Open No. 2021-25966 discloses a MEMS (Micro Electro Mechanical System) sensor. The MEMS sensor disclosed in Japanese Patent Laying-Open No. 2021-25966 includes a substrate. The substrate includes a first substrate and a second substrate. The first substrate and the second substrate are formed from monocrystalline silicon. The first substrate has a first surface and a second surface. The first surface and the second surface are end surfaces in the thickness direction of the first substrate. A cavity is formed in the second surface. The cavity is depressed toward the first surface. The second substrate is disposed on the second surface. Thus, the cavity is formed in the substrate. The first substrate and the second substrate are bonded to each other. A portion of the second substrate that is spaced from and faces the bottom surface of the cavity forms a membrane (diaphragm).

The MEMS sensor disclosed in Japanese Patent Laying-Open No. 2021-25966 operates by flexing the membrane under an external pressure. In the MEMS sensor disclosed in Japanese Patent Laying-Open No. 2021-25966, the depth of the cavity is designed in such a manner that the membrane and the bottom surface of the cavity are not brought into contact with each other by a pressure in a normal state of use. However, the membrane may be brought into contact with and stick to the bottom surface of the cavity due to, for example, the pressure of water used in a dicing step in which a blade is used, cleaning during substrate packaging, ultrasonic cleaning, blowing, or the like.

The sensor of the present disclosure includes a substrate. A cavity is formed in the substrate. The substrate includes a membrane spaced from and facing a bottom surface of the cavity. A plurality of protruding portions are formed on one of the bottom surface of the cavity and an inner surface of the membrane.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a sensor 100.

FIG. 2 is a cross-sectional view taken along II-II in FIG. 1.

FIG. 3 is a cross-sectional view taken along III-III in FIG. 2.

FIG. 4 is a partially enlarged view of IV in FIG. 2.

FIG. 5 is a cross-sectional view of a sensor 100 according to Modification 1.

FIG. 6 is a cross-sectional view of a sensor 100 according to Modification 2.

FIG. 7 is a manufacturing process diagram for a sensor 100.

FIG. 8 is a cross-sectional view illustrating a hard mask formation step S2.

FIG. 9 is a cross-sectional view illustrating a resist pattern formation step S3.

FIG. 10 is a plan view illustrating resist pattern formation step S3.

FIG. 11 is a cross-sectional view illustrating a first etching step S4.

FIG. 12 is a cross-sectional view illustrating a second etching step S5.

FIG. 13 is a cross-sectional view illustrating a third etching step S6.

FIG. 14 is a cross-sectional view illustrating a fourth etching step S7.

FIG. 15 is a cross-sectional view illustrating a substrate bonding step S8.

FIG. 16 is a cross-sectional view illustrating a first insulating film formation step S9.

FIG. 17 is a cross-sectional view illustrating a first ion implantation step S10.

FIG. 18 is a cross-sectional view illustrating a second insulating film formation step S11.

FIG. 19 is a cross-sectional view illustrating a contact hole formation step S12.

FIG. 20 is a cross-sectional view illustrating a second ion implantation step S13.

FIG. 21 is a cross-sectional view illustrating a pad formation step S14.

FIG. 22 is a cross-sectional view illustrating a protective film formation step S15.

FIG. 23 is a cross-sectional view of a sensor 100A.

FIG. 24 is a cross-sectional view of a sensor 200.

FIG. 25 is a manufacturing process diagram for sensor 200.

FIG. 26 is a cross-sectional view illustrating a first resist pattern formation step S17.

FIG. 27 is a cross-sectional view illustrating a first etching step S18.

FIG. 28 is a cross-sectional view illustrating a second resist pattern formation step S19.

FIG. 29 is a cross-sectional view illustrating a second etching step S20.

FIG. 30 is a cross-sectional view illustrating a third etching step S21.

FIG. 31 is a cross-sectional view illustrating an oxide film formation step S22.

FIG. 32 is a cross-sectional view illustrating a fourth etching step S23.

FIG. 33 is a cross-sectional view illustrating a fifth etching step S24.

FIG. 34 is a cross-sectional view illustrating a sixth etching step S25.

FIG. 35 is a cross-sectional view illustrating a heat treatment step S26.

### DESCRIPTION OF THE PREFERRED EMBODIMENTS

Embodiments of the present disclosure are described with reference to the drawings. In the following drawings, the same or corresponding parts are denoted by the same reference characters, and a description thereof is not herein repeated.

### Embodiment 1

A sensor according to Embodiment 1 is described. The sensor according to Embodiment 1 is herein referred to as sensor 100.

### <Configuration of Sensor 100>

A configuration of sensor 100 is described in the following.

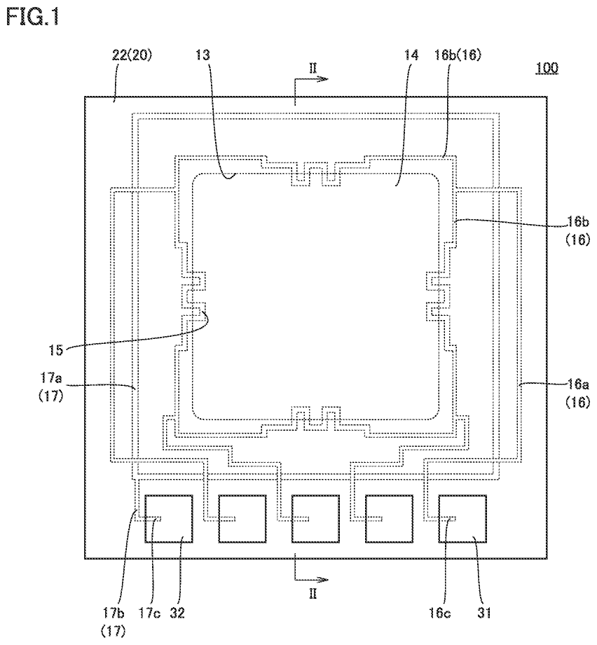

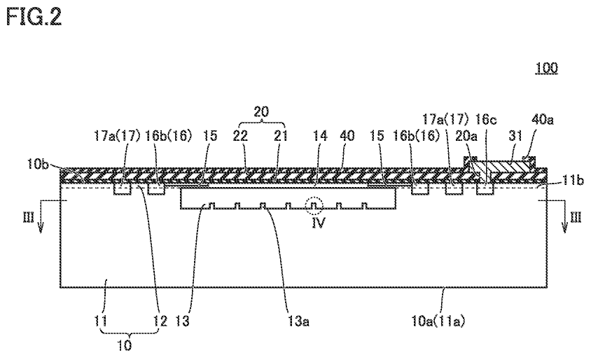

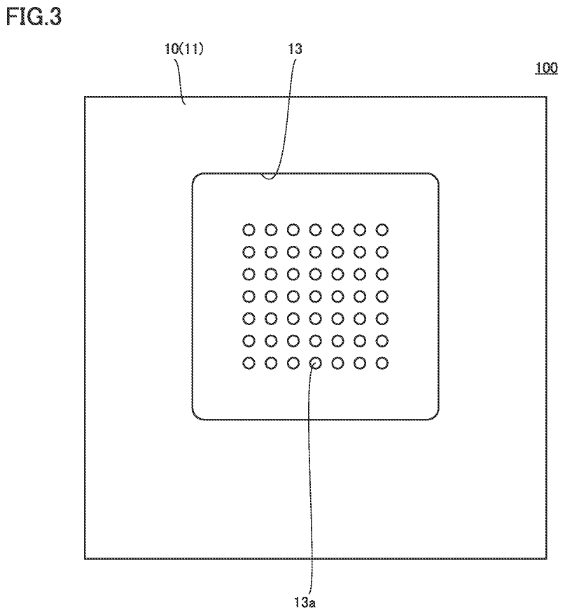

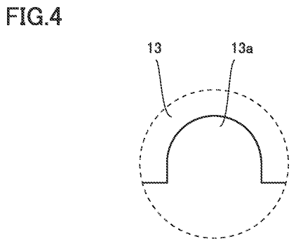

FIG. 1 is a plan view of sensor 100. In FIG. 1, a protective film 40 is not shown. FIG. 2 is a cross-sectional view taken along II-II in FIG. 1. FIG. 3 is a cross-sectional view taken along III-III in FIG. 2. FIG. 4 is a partially enlarged view of IV in FIG. 2. As shown in FIGS. 1 to 4, sensor 100 includes a substrate 10, an insulating film 20, a plurality of pads 31, a pad 32, and protective film 40.

Substrate 10 has a first surface 10a and a second surface 10b. First surface 10a and second surface 10b are respectively opposite end surfaces in the thickness direction of substrate 10. Substrate 10 includes, for example, a first substrate 11 and a second substrate 12. The material forming first substrate 11 and second substrate 12 is, for example, monocrystalline silicon. The conductivity type of first substrate 11 and the conductivity type of second substrate 12 are a first conductivity type. The first conductivity type is, for example, n type.

First substrate 11 has a first surface 11a and a second surface 11b. First surface 11a and second surface 11b are respectively opposite end surfaces in the thickness direction of first substrate 11. First surface 11a forms first surface 10a. Second substrate 12 is disposed on second surface 11b. First substrate 11 and second substrate 12 are bonded to each other.

A cavity 13 is formed in second surface 11b. Cavity 13 has a rectangular shape as seen in a plan view. The “rectangular shape” includes the one having rounded corners. Second surface 11b is depressed toward first surface 11a (first surface 10a) in cavity 13. As described above, second substrate 12 is disposed on second surface 11b, and therefore, cavity 13 is formed in substrate 10.

A plurality of protruding portions 13a are formed on the bottom surface of cavity 13. Protruding portions 13a protrude from the bottom surface of cavity 13 toward the side opposite to first surface 10a (first surface 11a). As seen in a plan view, a plurality of protruding portions 13a are arranged, for example, in a lattice pattern. The upper surface of protruding portion 13a is preferably formed as a curved surface.

Second substrate 12 includes a membrane 14. Membrane 14 is a part of second substrate 12 that is spaced from and faces the bottom surface of cavity 13.

A plurality of resistors 15 are formed on membrane 14. Resistor 15 is formed on second surface 10b. Resistor 15 is formed by implanting a dopant. The conductivity type of resistor 15 is a second conductivity type. The second conductivity type is, for example, p type. In the example shown in FIG. 1, the number of a plurality of resistors 15 is four. Each of a plurality of resistors 15 is disposed on the outer edge of membrane 14 along a respective side of membrane 14 as seen in a plan view.

A plurality of interconnects 16 are further formed on substrate 10. Interconnects 16 are formed on second surface 10b. Interconnects 16 are arranged mainly to avoid membrane 14. Interconnect 16 is formed by implanting a dopant. The conductivity type of interconnect 16 is the second conductivity type.

Interconnects 16 include a first portion 16a and two second portions 16b. One end of first portion 16a is electrically connected to a contact 16c. Contact 16c is formed by implanting a dopant. The conductivity type of contact 16c is the second conductivity type. Contact 16c overlaps pad 31 as seen in a plan view.

Interconnect 16 is branched, at one end of first portion 16a, into two second portions 16b. One of second portions 16b is electrically connected to one of a plurality of resistors 15, and the other one of second portions 16b is electrically connected to another one of a plurality of resistors 15. In this way, a plurality of resistors 15 are connected by a plurality of interconnects 16 to form a bridge circuit.

An interconnect 17 is further formed on substrate 10. Interconnect 17 is formed on second surface 10b. Interconnect 17 is arranged to avoid membrane 14. Interconnect 17 is formed by implanting a dopant. The conductivity type of interconnect 17 is the first conductivity type. Interconnect 17 includes a first portion 17a and a second portion 17b. First portion 17a is formed in an annular shape as seen in a plan view. One end of second portion 17b is electrically connected to first portion 17a. The other end of second portion 17b is electrically connected to a contact 17c. Contact 17c is formed by implanting a dopant. The conductivity type of contact 17c is the first conductivity type. Contact 17c overlaps pad 32 as seen in a plan view.

Insulating film 20 is disposed on second surface 10b. Insulating film 20 includes, for example, a first insulating film 21 and a second insulating film 22. First insulating film 21 is disposed on second surface 10b. Second insulating film 22 is disposed on first insulating film 21. First insulating film 21 and second insulating film 22 are formed, for example, from silicon oxide. A contact hole 20a is formed in insulating film 20. A contact hole 20b (not shown) is formed in insulating film 20. Contact hole 20a and contact hole 20b extend through insulating film 20 in the thickness direction. Contact 16c and contact 17c are exposed from contact hole 20a and contact hole 20b, respectively.

Pad 31 is disposed on insulating film 20. Pad 31 is electrically connected to contact 16c by being embedded in contact hole 20a. Pad 32 is disposed on insulating film 20. Pad 32 is electrically connected to contact 17c by being embedded in contact hole 20b. A plurality of pads 31 and pad 32 are arranged, for example, in a line as seen in a plan view.

For example, a power supply voltage is supplied to a pair of pads 31 that are electrically connected to resistor 15. As the external pressure (e.g., atmospheric pressure) changes, membrane 14 is flexed due to a difference from the pressure in cavity 13. As membrane 14 is flexed, the value of the electrical resistance of resistor 15 changes. As the value of the electrical resistance of resistor 15 changes, the voltage between pads 31 of a pad pair that are electrically connected to resistor 15 changes. Sensor 100 is capable of detecting the external pressure by detecting this voltage change. Specifically, sensor 100 is, for example, a pressure sensor such as an atmospheric pressure sensor. For example, a substrate potential is supplied to substrate 10 through pad 32.

Protective film 40 is disposed on insulating film 20 so as to cover a plurality of pads 31 and pad 32. A plurality of openings 40a are formed in protective film 40. An opening 40b (not shown) is formed in protective film 40. Openings 40a and opening 40b extend through protective film 40 in the thickness direction. A plurality of pads 31 are exposed from respective openings 40a. Pad 32 is exposed from opening 40b. Protective film 40 is formed, for example, from silicon nitride.

### Modification 1

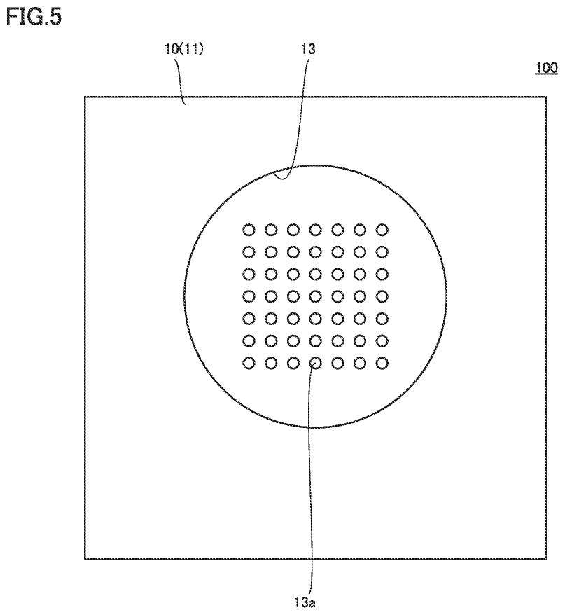

FIG. 5 is a cross-sectional view of a sensor 100 according to Modification 1. FIG. 5 shows a cross section taken at a position corresponding to III-III in FIG. 2. As shown in FIG. 5, cavity 13 may be circular as seen in a plan view.

### Modification 2

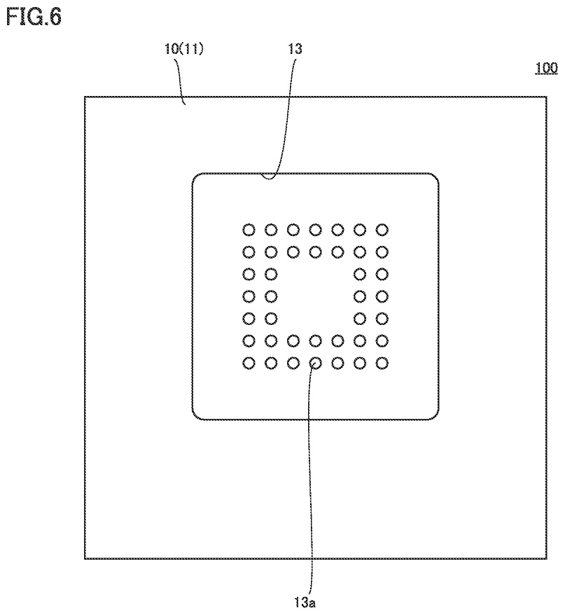

FIG. 6 is a cross-sectional view of a sensor 100 according to Modification 2. FIG. 6 shows a cross section taken at a position corresponding to III-III in FIG. 2. As shown in FIG. 6, a plurality of protruding portions 13a may be arranged around a central portion of the bottom surface of cavity 13 as seen in a plan view. As long as a central portion of the bottom surface of cavity 13 includes a region where no protruding portion 13a is located as seen in a plan view and the width of this region is 10 μm or more, this arrangement is regarded as “a plurality of protruding portions 13a are arranged around a central portion of the bottom surface of cavity 13 as seen in a plan view.”

### <Method for Manufacturing Sensor 100>

A method for manufacturing sensor 100 is described in the following.

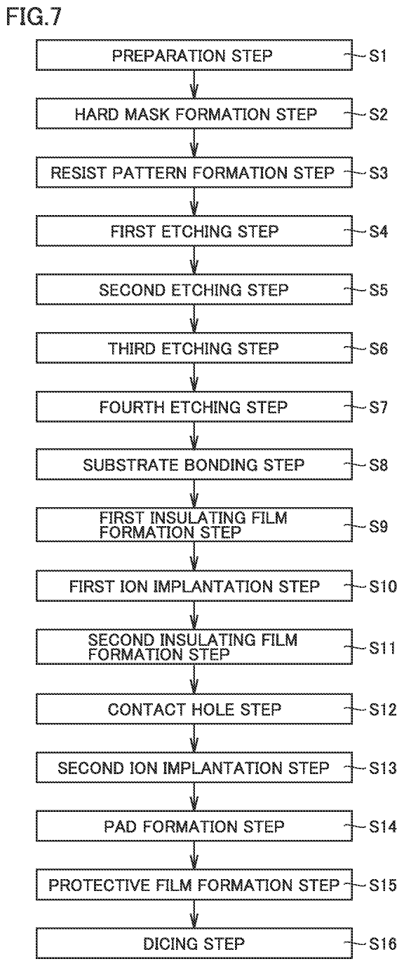

FIG. 7 is a manufacturing process diagram for sensor 100. As shown in FIG. 7, the method for manufacturing sensor 100 includes a preparation step S1, a hard mask formation step S2, a resist pattern formation step S3, a first etching step S4, a second etching step S5, a third etching step S6, a fourth etching step S7, a substrate bonding step S8, a first insulating film formation step S9, a first ion implantation step S10, a second insulating film formation step S11, a contact hole formation step S12, a second ion implantation step S13, a pad formation step S14, a protective film formation step S15, and a dicing step S16.

In preparation step S1, first substrate 11 is prepared. After preparation step S1, hard mask formation step S2 is performed.

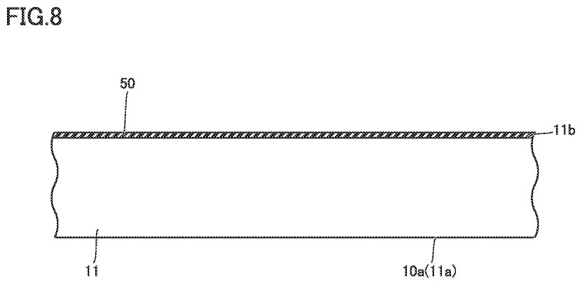

FIG. 8 is a cross-sectional view illustrating hard mask formation step S2. As shown in FIG. 8, in hard mask formation step S2, a hard mask 50 is formed on second surface 11b by thermal oxidation, for example. Hard mask 50 is formed, for example, from silicon oxide. After hard mask formation step S2, resist pattern formation step S3 is performed.

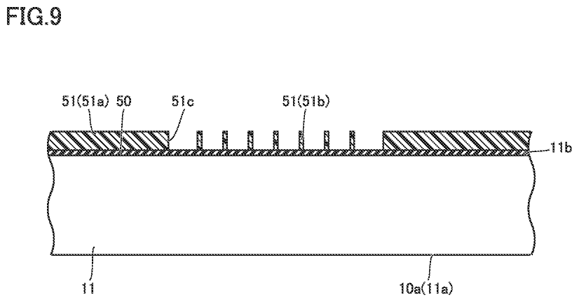

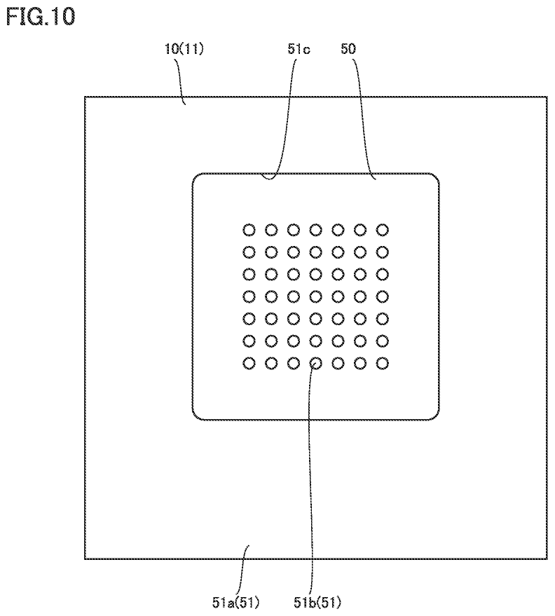

FIG. 9 is a cross-sectional view illustrating resist pattern formation step S3. FIG. 10 is a plan view illustrating resist pattern formation step S3. As shown in FIGS. 9 and 10, in resist pattern formation step S3, a resist pattern 51 is formed on hard mask 50. Resist pattern 51 includes a first portion 51a and a plurality of second portions 51b. First portion 51a has an opening 51c.

First portion 51a is located on the entire surface of hard mask 50 except for opening 51c. A plurality of second portions 51b are arranged inside the opening edge of opening 51c as seen in a plan view. Resist pattern 51 is formed by applying a photoresist on hard mask 50 and exposing and developing the applied photoresist. After resist pattern formation step S3, first etching step S4 is performed.

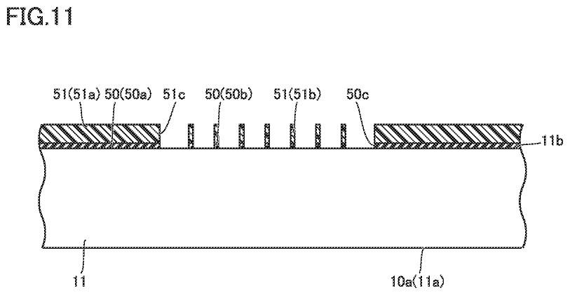

FIG. 11 is a cross-sectional view illustrating first etching step S4. As shown in FIG. 11, in first etching step S4, hard mask 50 is etched using resist pattern 51. This etching is anisotropic dry etching, for example. Accordingly, hard mask 50 is patterned to have a first portion 50a and a plurality of second portions 50b. First portion 50a has an opening 50c.

First portion 50a is located on the entire surface of second surface 11b except for opening 50c. A plurality of second portions 50b are arranged inside the opening edge of opening 50c as seen in a plan view. A plurality of second portions 50b are located under a plurality of second portions 51b, respectively. Resist pattern 51 is removed after the etching, and only first portion 51a is formed again. After first etching step S4, second etching step S5 is performed.

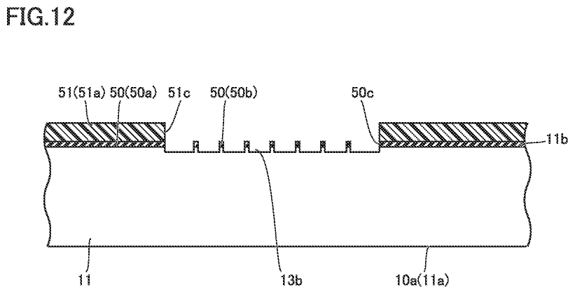

FIG. 12 is a cross-sectional view illustrating second etching step S5. As shown in FIG. 12, in second etching step S5, first substrate 11 is etched using hard mask 50. This etching is anisotropic dry etching, for example. Accordingly, depressed portions 13b are formed in second surface 11b. After second etching step S5, third etching step S6 is performed.

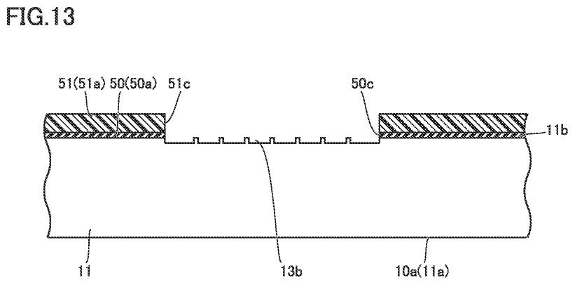

FIG. 13 is a cross-sectional view illustrating third etching step S6. As shown in FIG. 13, in third etching step S6, hard mask 50 is etched using resist pattern 51. This etching is anisotropic dry etching, for example. Accordingly, a plurality of second portions 50b are removed. After third etching step S6, fourth etching step S7 is performed.

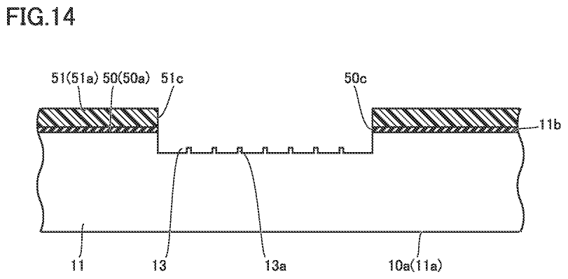

FIG. 14 is a cross-sectional view illustrating fourth etching step S7. As shown in FIG. 14, in fourth etching step S7, first substrate 11 is etched using hard mask 50 and resist pattern 51. This etching is anisotropic dry etching, for example. Accordingly, second surface 11b exposed from opening 50c (opening 51c) is etched down to form cavity 13 and a plurality of protruding portions 13a. After fourth etching step S7, hard mask 50 and resist pattern 51 are removed. After fourth etching step S7, substrate bonding step S8 is performed.

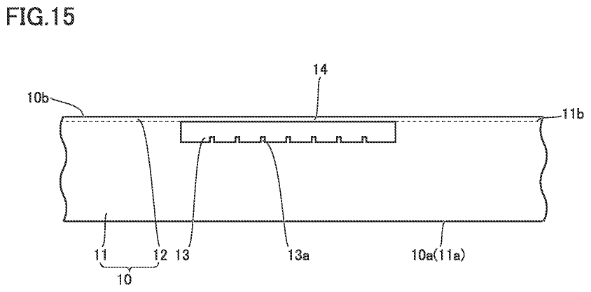

FIG. 15 is a cross-sectional view illustrating substrate bonding step S8. As shown in FIG. 15, in substrate bonding step S8, second substrate 12 is bonded to first substrate 11 (second surface 11b). In substrate bonding step S8, firstly second substrate 12 is disposed on second surface 11b. Secondly, second substrate 12 is heated while being subjected to a pressure applied toward second surface 11b. Accordingly, second substrate 12 is bonded to second surface 11b. After substrate bonding step S8, first insulating film formation step S9 is performed.

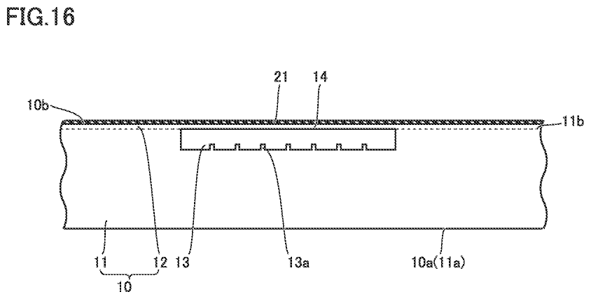

FIG. 16 is a cross-sectional view illustrating first insulating film formation step S9. As shown in FIG. 16, in first insulating film formation step S9, substrate 10 is thermally oxidized, for example, to form first insulating film 21 on second surface 10b. After first insulating film formation step S9, first ion implantation step S10 is performed.

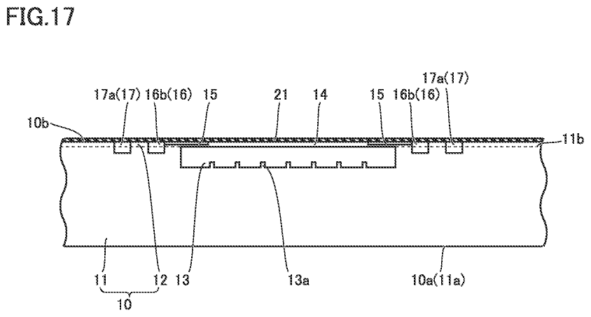

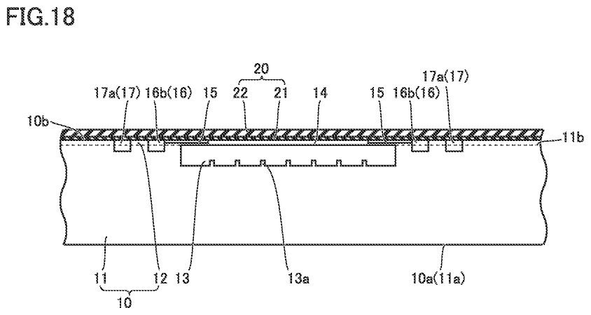

FIG. 17 is a cross-sectional view illustrating first ion implantation step S10. As shown in FIG. 17, in first ion implantation step S10, resistor 15, interconnect 16, and interconnect 17 are formed by ion implantation. After first ion implantation step S10, second insulating film formation step S11 is performed. FIG. 18 is a cross-sectional view illustrating second insulating film formation step S11. As shown in FIG. 18, in second insulating film formation step S11, second insulating film 22 is formed for example by CVD (Chemical Vapor Deposition). After second insulating film formation step S11, contact hole formation step S12 is performed.

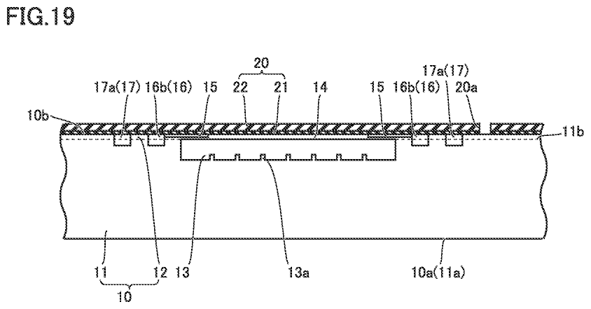

FIG. 19 is a cross-sectional view illustrating contact hole formation step S12. As shown in FIG. 19, in contact hole formation step S12, contact hole 20a is formed in insulating film 20 by anisotropic dry etching, for example. In contact hole formation step S12, contact hole 20b (not shown) is also formed by anisotropic dry etching, for example. After contact hole formation step S12, second ion implantation step S13 is performed.

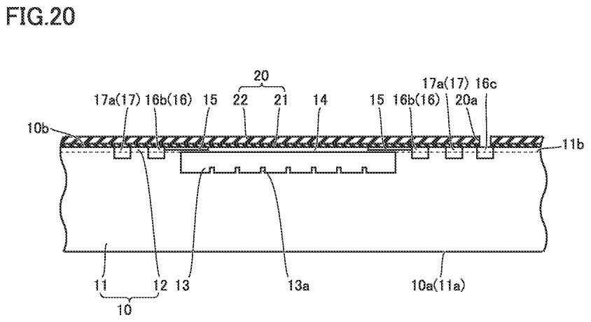

FIG. 20 is a cross-sectional view illustrating second ion implantation step S13. As shown in FIG. 20, in second ion implantation step S13, contact 16c is formed by ion implantation. In second ion implantation step S13, contact 17c (not shown) is also formed by ion implantation. After second ion implantation step S13, pad formation step S14 is performed.

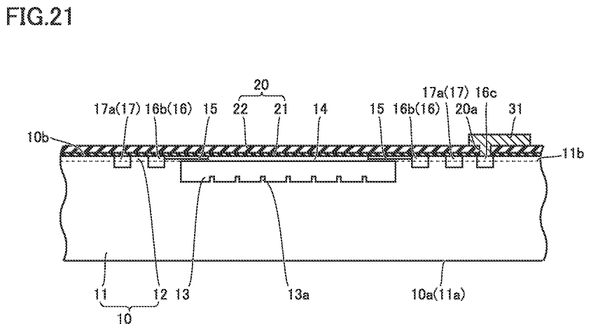

FIG. 21 is a cross-sectional view illustrating pad formation step S14. As shown in FIG. 21, in pad formation step S14, pad 31 is formed on insulating film 20. In pad formation step S14, firstly a constituent material of pad 31 is deposited on insulating film 20 by sputtering, for example. At this time, the constituent material of pad 31 is also embedded in contact hole 20a. Secondly, a resist pattern is formed on the deposited constituent material of pad 31. The resist pattern is formed by applying a photoresist and exposing and developing the applied photoresist. Thirdly, anisotropic dry etching, for example, is performed using the resist pattern, to pattern the deposited constituent material of pad 31. Pad 32 (not shown) is also formed through these steps. After pad formation step S14, protective film formation step S15 is performed.

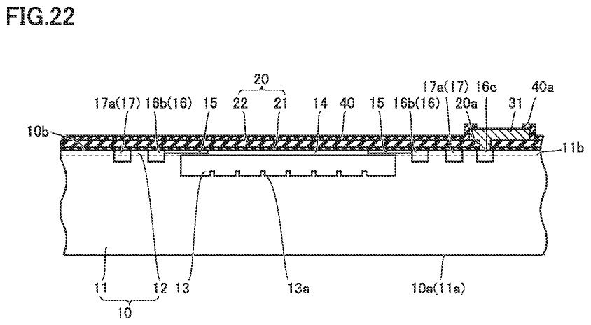

FIG. 22 is a cross-sectional view illustrating protective film formation step S15. As shown in FIG. 22, in protective film formation step S15, protective film 40 is formed. In protective film formation step S15, firstly a constituent material of protective film 40 is deposited for example by CVD to cover pads 31 and 32 (not shown). Secondly, a resist pattern is formed on the deposited constituent material of protective film 40. The resist pattern is formed by applying a photoresist and exposing and developing the applied photoresist. Thirdly, anisotropic dry etching, for example, is performed using the resist pattern, to pattern the deposited constituent material of protective film 40 and thereby form opening 40a. Opening 40b (not shown) is also formed by the dry etching. After protective film formation step S15, dicing step S16 is performed.

In dicing step S16, substrate 10, insulating film 20, and protective film 40 are cut with a blade, for example, to be divided into a plurality of sensors 100. The cutting with a blade is performed, for example, while water is supplied. In this way, the structure of sensor 100 shown in FIGS. 1 to 3 is formed.

### <Effects of Sensor 100>

Effects of sensor 100 are described below in comparison with a sensor according to a comparative example. The sensor according to the comparative example is herein referred to as sensor 100A.

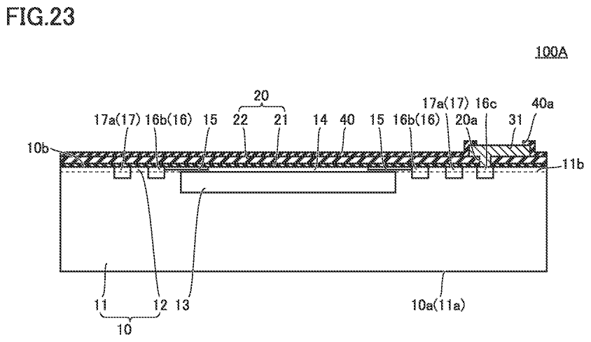

FIG. 23 is a cross-sectional view of sensor 100A. FIG. 23 shows a cross section taken at a position corresponding to FIG. 2. As shown in FIG. 23, in sensor 100A, protruding portions 13a are not formed on the bottom surface of cavity 13. Except for this, the configuration of sensor 100A is the same as the configuration of sensor 100.

In sensor 100A, the depth of cavity 13 is designed such that membrane 14 which is flexed when the external pressure increases is not brought into contact with the bottom surface of cavity 13 under a pressure in a normal state of use. However, a pressure higher than or equal to the pressure in the normal state of use may be applied to membrane 14, due to water supplied in dicing step S16, for example. As a result, in sensor 100A, membrane 14 may be brought into contact with the bottom surface of cavity 13. In sensor 100A, the bottom surface of cavity 13 is flat and membrane 14 and the bottom surface of cavity 13 are brought into surface contact with each other, so that membrane 14 is likely to stick to the bottom surface of cavity 13.

In contrast, in sensor 100, a plurality of protruding portions 13a are formed on the bottom surface of cavity 13, and therefore, contact between membrane 14 and the bottom surface of cavity 13 is close to point contact. Therefore, in sensor 100, membrane 14 is less likely to stick to the bottom surface of cavity 13. When the upper surface of protruding portion 13a is formed as a curved surface, contact between membrane 14 and the bottom surface of cavity 13 is closer to point contact, so that membrane 14 is far less likely to stick to the bottom surface of cavity 13.

A central portion of membrane 14 as seen in a plan view is likely to flex to a greater extent. As a result, the contact surface pressure between membrane 14 and the bottom surface of cavity 13 is larger across the central portion of membrane 14 as seen in a plan view. When a plurality of protruding portions 13a are formed around a central portion of the bottom surface of cavity 13 as seen in a plan view, membrane 14 and the bottom surface of cavity 13 are brought into contact with each other in a location where the surface contact pressure is lower, so that membrane 14 is far less likely to stick to the bottom surface of cavity 13.

### Embodiment 2

A sensor according to Embodiment 2 is described. The sensor according to Embodiment 2 is herein referred to as sensor 200. Differences from sensor 100 are mainly described, and the same description is not repeated herein.

### <Configuration of Sensor 200>

A configuration of sensor 200 is described in the following.

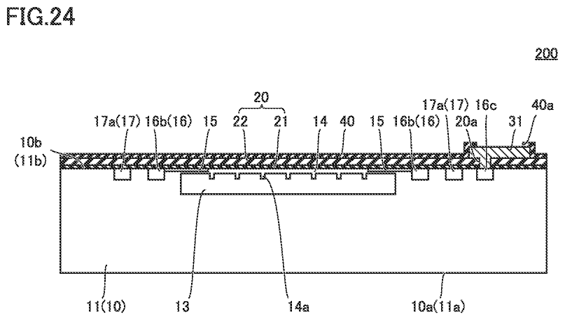

FIG. 24 is a cross-sectional view of sensor 200. FIG. 24 shows a cross section taken at a position corresponding to FIG. 2. As shown in FIG. 24, sensor 200 includes a substrate 10, an insulating film 20, a plurality of pads 31, a pad 32, and a protective film 40. In this respect, the configuration of sensor 200 is the same as the configuration of sensor 100.

In sensor 200, substrate 10 is formed of a first substrate 11. Namely, in sensor 200, substrate 10 does not include second substrate 12 and second surface 10b is formed of second surface 11b. In sensor 200, protruding portions 14a are formed instead of protruding portions 13a. Protruding portions 14a are formed on the inner surface of membrane 14 (the surface facing the bottom surface of cavity 13). In these respects, the configuration of sensor 200 is different from the configuration of sensor 100. The upper surface of protruding portion 14a may be formed as a curved surface (not shown), like the upper surface of protruding portion 13a.

### <Method for Manufacturing Sensor 200>

A method for manufacturing sensor 200 is described in the following.

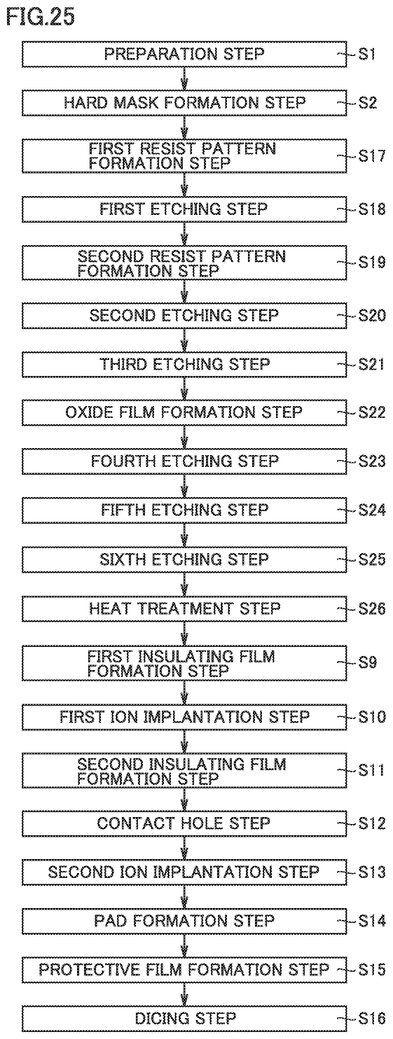

FIG. 25 is a manufacturing process diagram for sensor 200. As shown in FIG. 25, the method for manufacturing sensor 200 includes a preparation step S1, a hard mask formation step S2, a first insulating film formation step S9, a first ion implantation step S10, a second insulating film formation step S11, a contact hole formation step S12, a second ion implantation step S13, a pad formation step S14, a protective film formation step S15, and a dicing step S16. In this respect, the method for manufacturing sensor 200 is the same as the method for manufacturing sensor 100.

The method for manufacturing sensor 200 does not include resist pattern formation step S3, first etching step S4, second etching step S5, third etching step S6, fourth etching step S7, and substrate bonding step S8. The method for manufacturing sensor 200 includes, instead of these steps, a first resist pattern formation step S17, a first etching step S18, a second resist pattern formation step S19, a second etching step S20, a third etching step S21, an oxide film formation step S22, a fourth etching step S23, a fifth etching step S24, a sixth etching step S25, and a heat treatment step S26. In these respects, the method for manufacturing sensor 200 is different from the method for manufacturing sensor 100. First resist pattern formation step S17 is performed after hard mask formation step S2.

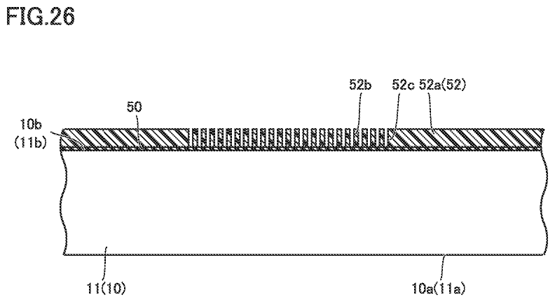

FIG. 26 is a cross-sectional view illustrating first resist pattern formation step S17. As shown in FIG. 26, in first resist pattern formation step S17, a resist pattern 52 is formed. Resist pattern 52 includes a first portion 52a and a plurality of second portions 52b First portion 52a has an opening 52c. A plurality of second portions 52b are arranged inside the opening edge of opening 52c as seen in a plan view. Resist pattern 52 is formed by applying a photoresist on hard mask 50 and exposing and developing the applied photoresist. After first resist pattern formation step S17, first etching step S18 is performed.

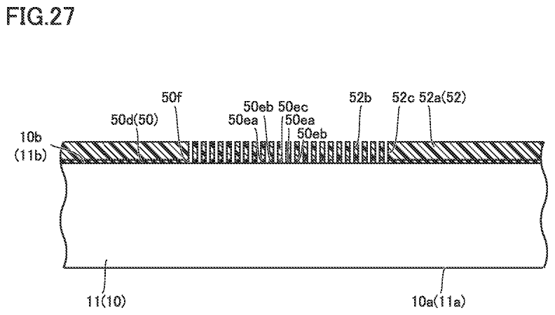

FIG. 27 is a cross-sectional view illustrating first etching step S18. As shown in FIG. 27, in first etching step S18, hard mask 50 is patterned using resist pattern 52, so as to have a first portion 50d and a plurality of second portions 50e. First portion 50d has an opening 50f. A plurality of second portions 50e are arranged inside the opening edge of opening 50f as seen in a plan view. This etching is anisotropic dry etching, for example. After the etching, resist pattern 52 is removed. After first etching step S18, second resist pattern formation step S19 is performed.

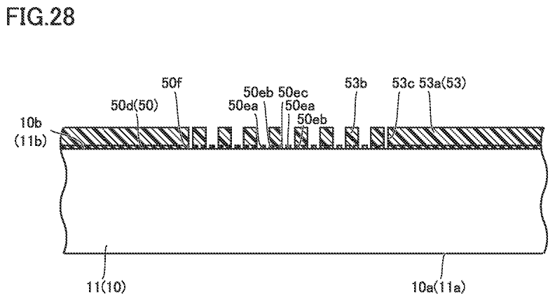

FIG. 28 is a cross-sectional view illustrating second resist pattern formation step S19. As shown in FIG. 28, in second resist pattern formation step S19, a resist pattern 53 is formed. Resist pattern 53 includes a first portion 53a and a second portion 53b. First portion 53a has an opening 53c. A plurality of second portions 53b are arranged inside opening 53c as seen in a plan view.

Two second portions 50e adjacent to each other are herein referred to as second portion 50ea and second portion 50eb respectively. A second portion 50e between one set of second portions 50ea and 50eb and another set of second portions 50ea and 50eb adjacent to the one set is herein referred to as second portion 50ec. Second portion 53b is disposed on second portion 50ec, second portion 50eb, and second surface 11b located between second portion 50ec and second portion 50eb. Meanwhile, second portion 53b is not disposed on second portion 50ea, second surface 11b located between second portion 50ea and second portion 50ec, and second surface 11b located between second portion 50eb and second portion 50ea. After second resist pattern formation step S19, second etching step S20 is performed.

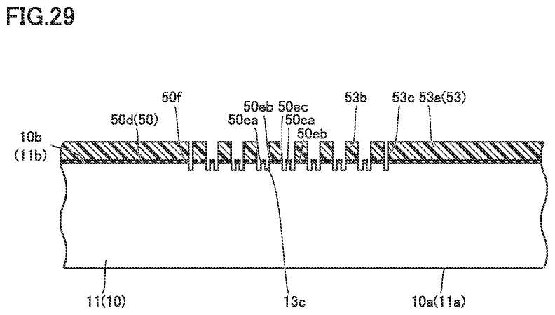

FIG. 29 is a cross-sectional view illustrating second etching step S20. As shown in FIG. 29, in second etching step S20, first substrate 11 is etched using hard mask 50 and resist pattern 53 to thereby form depressed portions 13c. Depressed portions 13c are formed in second surface 11b located between second portion 50ea and second portion 50ec and in second surface 11b located between second portion 50eb and second portion 50ea. This etching is anisotropic dry etching, for example. After the etching, resist pattern 53 is removed. After second etching step S20, third etching step S21 is performed.

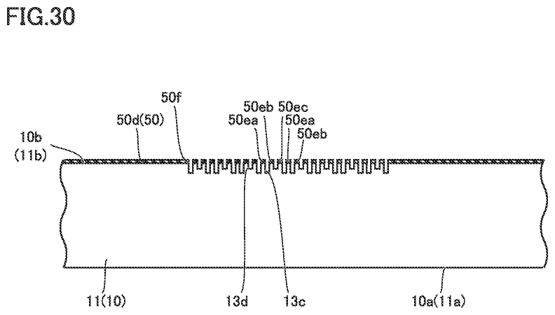

FIG. 30 is a cross-sectional view illustrating third etching step S21. As shown in FIG. 30, in third etching step S21, first substrate 11 is etched using hard mask 50 to thereby form a depressed portion 13d. Depressed portion 13d is formed in second surface 11b located between second portion 50ec and second portion 50eb. By performing the etching, depressed portion 13c is etched down toward first surface 11a. Therefore, depressed portion 13c is deeper than depressed portion 13d. This etching is anisotropic dry etching, for example. After third etching step S21, oxide film formation step S22 is performed.

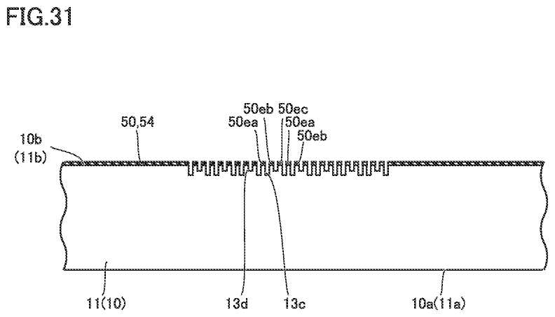

FIG. 31 is a cross-sectional view illustrating oxide film formation step S22. As shown in FIG. 31, in oxide film formation step S22, an oxide film 54 is formed for example by CVD. Oxide film 54 is formed for example from silicon oxide. Oxide film 54 is disposed on hard mask 50. Oxide film 54 also covers the side surface of depressed portion 13c, the bottom surface of depressed portion 13c, the side surface of depressed portion 13d, and the bottom surface of depressed portion 13d (which is not shown). After oxide film formation step S22, fourth etching step S23 is performed.

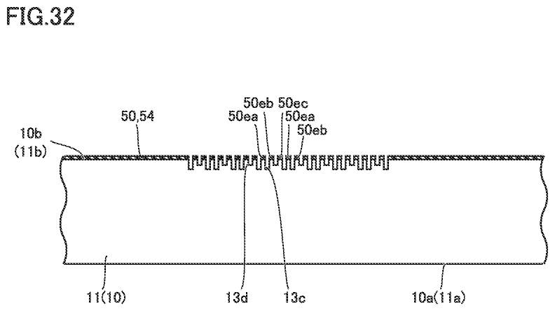

FIG. 32 is a cross-sectional view illustrating fourth etching step S23. As shown in FIG. 32, in fourth etching step S23, etching is performed to remove oxide film 54 located on the bottom surface of depressed portion 13c and the bottom surface of depressed portion 13d. This etching is anisotropic dry etching, for example. After fourth etching step S23, fifth etching step S24 is performed.

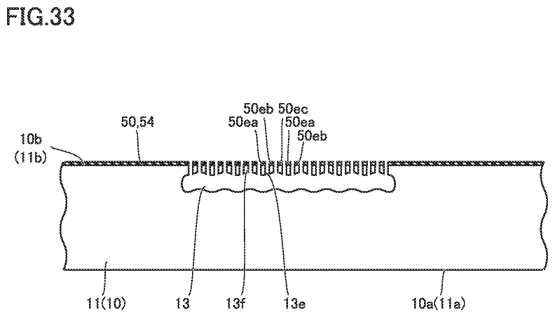

FIG. 33 is a cross-sectional view illustrating fifth etching step S24. As shown in FIG. 33, in fifth etching step S24, etching is performed to form cavity 13. This etching is, for example, isotropic wet etching through depressed portion 13c and depressed portion 13d. By the etching, depressed portion 13c and depressed portion 13d become a through hole 13e and a through hole 13f, respectively. Through hole 13e and through hole 13f communicate with cavity 13. After fifth etching step S24, sixth etching step S25 is performed.

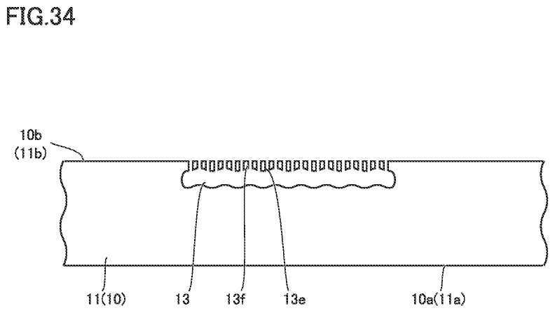

FIG. 34 is a cross-sectional view illustrating sixth etching step S25. As shown in FIG. 34, in sixth etching step S25, etching is performed to remove hard mask 50 and oxide film 54. This etching is isotropic wet etching, for example. After sixth etching step S25, heat treatment step S26 is performed.

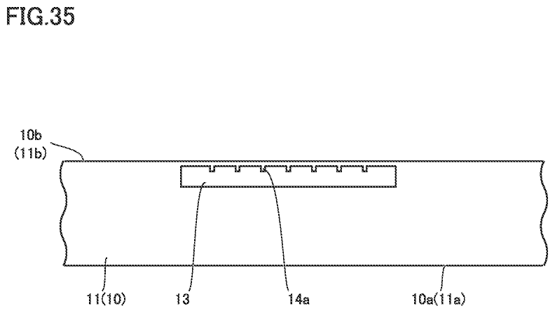

FIG. 35 is a cross-sectional view illustrating heat treatment step S26. As shown in FIG. 35, in heat treatment step S26, heat treatment is performed on first substrate 11 in a reduced-pressure environment. As a result, constituent atoms of first substrate 11 move to close through hole 13e and through hole 13f and thereby form membrane 14, and the portion of first substrate 11 that is located between two through holes 13e adjacent to each other becomes protruding portion 14a. The side surface and the bottom surface of cavity 13 are made flat to some extent by the movement of the constituent atoms of first substrate 11 caused by the heat treatment.

The structure of sensor 200 shown in FIG. 24 is formed by sequentially performing first insulating film formation step S9, first ion implantation step S10, second insulating film formation step S11, contact hole formation step S12, second ion implantation step S13, pad formation step S14, protective film formation step S15, and dicing step S16, after heat treatment step S26.

### <Effects of Sensor 200>

Effects of sensor 200 are described below.

In sensor 200, a plurality of protruding portions 14a are formed on the inner surface of membrane 14, and therefore, contact between membrane 14 and the bottom surface of cavity 13 is close to point contact. Therefore, in sensor 200, membrane 14 is less likely to stick to the bottom surface of cavity 13. In sensor 200, substrate 10 can be formed of first substrate 11 only, without using second substrate 12, which enables reduction of the manufacturing cost.

### APPENDIXES

The above-described embodiments include the following features.

### Appendix 1

A sensor comprising a substrate, wherein
a cavity is formed in the substrate,
the substrate includes a membrane spaced from and facing a bottom surface of the cavity, and
a plurality of protruding portions are formed on one of the bottom surface and an inner surface of the membrane.

### Appendix 2

The sensor according to Appendix 1, wherein the plurality of protruding portions are formed on the bottom surface.

### Appendix 3

The sensor according to Appendix 2, wherein the plurality of protruding portions are arranged around a central portion of the bottom surface as seen in a plan view.

### Appendix 4

The sensor according to Appendix 2 or 3, wherein
the substrate includes a first substrate and a second substrate,
the first substrate has a first surface and a second surface that is an opposite surface to the first surface,
the second substrate is disposed on the second surface,
the cavity is formed in the second surface, and
the membrane is a part of the second substrate that is spaced from and faces the bottom surface.

### Appendix 5

The sensor according to Appendix 1, wherein the plurality of protruding portions are formed on the inner surface.

### Appendix 6

The sensor according to Appendix 5, wherein the plurality of protruding portions are arranged around a central portion of the inner surface as seen in a plan view.

### Appendix 7

The sensor according to Appendix 5 or 6, wherein
the substrate is formed of a first substrate,
the cavity is formed in the first substrate, and
the membrane is a part of the first substrate that is spaced from and faces the bottom surface.

### Appendix 8

The sensor according to any one of Appendixes 1 to 7, wherein an upper surface of each of the plurality of protruding portions is formed as a curved surface.

Although the embodiments of the present invention have been described, it should be construed that the embodiments disclosed herein are given by way of illustration and example only and are not to be taken by way of limitation. It is intended that the scope of the present invention is defined by the claims and encompasses all variations equivalent in meaning and scope to the claims.

What is claimed is:

1. A sensor comprising a substrate, wherein
a cavity is formed in the substrate,
the substrate includes a membrane spaced from and facing a bottom surface of the cavity, and
a plurality of protruding portions are formed on one of the bottom surface and an inner surface of the membrane.

2. The sensor according to claim 1, wherein the plurality of protruding portions are formed on the bottom surface.

3. The sensor according to claim 2, wherein the plurality of protruding portions are arranged around a central portion of the bottom surface as seen in a plan view.

4. The sensor according to claim 2, wherein
the substrate includes a first substrate and a second substrate,
the first substrate has a first surface and a second surface that is an opposite surface to the first surface,
the second substrate is disposed on the second surface,
the cavity is formed in the second surface, and
the membrane is a part of the second substrate that is spaced from and faces the bottom surface.

5. The sensor according to claim 1, wherein the plurality of protruding portions are formed on the inner surface.

6. The sensor according to claim 5, wherein the plurality of protruding portions are arranged around a central portion of the inner surface as seen in a plan view.

7. The sensor according to claim 5, wherein
the substrate is formed of a first substrate,
the cavity is formed in the first substrate, and
the membrane is a part of the first substrate that is spaced from and faces the bottom surface.

8. The sensor according to claim 1, wherein an upper surface of each of the plurality of protruding portions is formed as a curved surface.
